(19) United States
(12) Patent Application Publication
(10) Pub. No.: US 2014/0355278 A1
(43) Pub. Date: Dec. 4, 2014

(54) ATTACHMENT MECHANISM FOR PROJECTION LAMP

(71) Applicant: Ingrasys Technology Inc., Taoyuan (TW)

(72) Inventor: SHU-YUN HUANG, Taoyuan (TW)

(73) Assignee: Ingrasys Technology Inc., Taoyuan (TW)

(21) Appl. No.: 14/196,718

(22) Filed: Mar. 4, 2014

(30) Foreign Application Priority Data
Jun. 4, 2013 (TW) 102119843

(51) Int. Cl. F21V 21/26

(52) U.S. Cl. CPC F21V 21/26
USPC 362/427

(57) ABSTRACT

An attachment mechanism for two projection lamps includes a fastening member, a pivot member pivotably connected to the fastening member about a first axis, and two pairs of linkage poles pivotably connected to the pivot member about a second axis perpendicular to the first axis. Each pair of linkage poles includes two linkage poles, one above another. Each pair of linkage poles is fastened to opposite ends of one projection lamp.

### FIELD

The present disclosure relates to an attachment mechanism for projection lamps.

### BACKGROUND

Projection lamps are mounted to walls by attachment mechanisms. However, each projection lamp needs one attachment mechanism to be mounted to the wall, which is costly.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled, isometric view of an exemplary embodiment of an attachment mechanism and two projection lamps.

FIG. 2 is an enlarged view of one of the projection lamps of FIG. 1, and viewed from another perspective.

FIG. 3 is an exploded, isometric view of the attachment mechanism of FIG. 1.

FIG. 4 is an assembled, isometric view of FIG. 3.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one”.

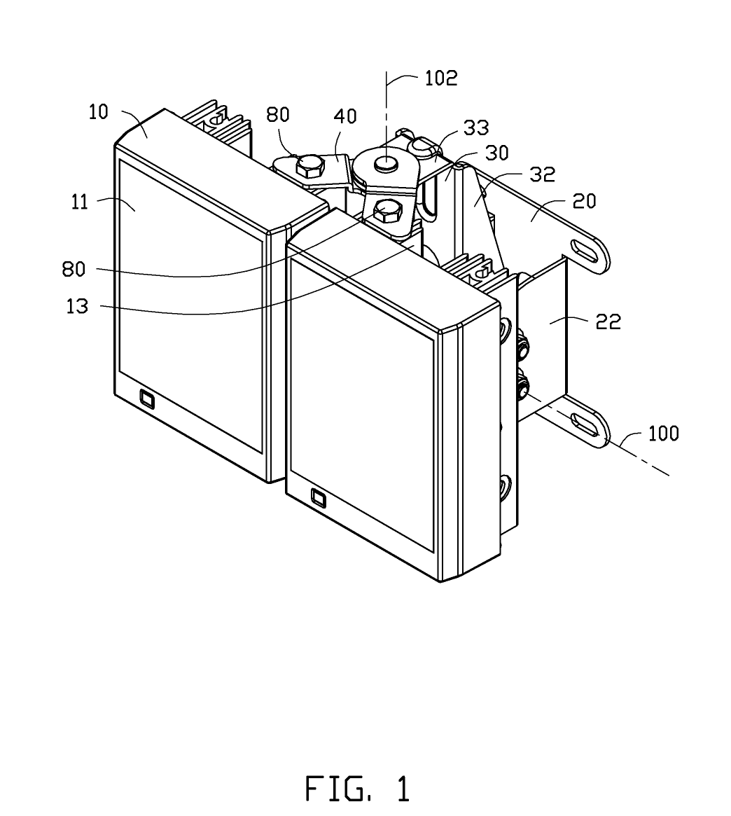

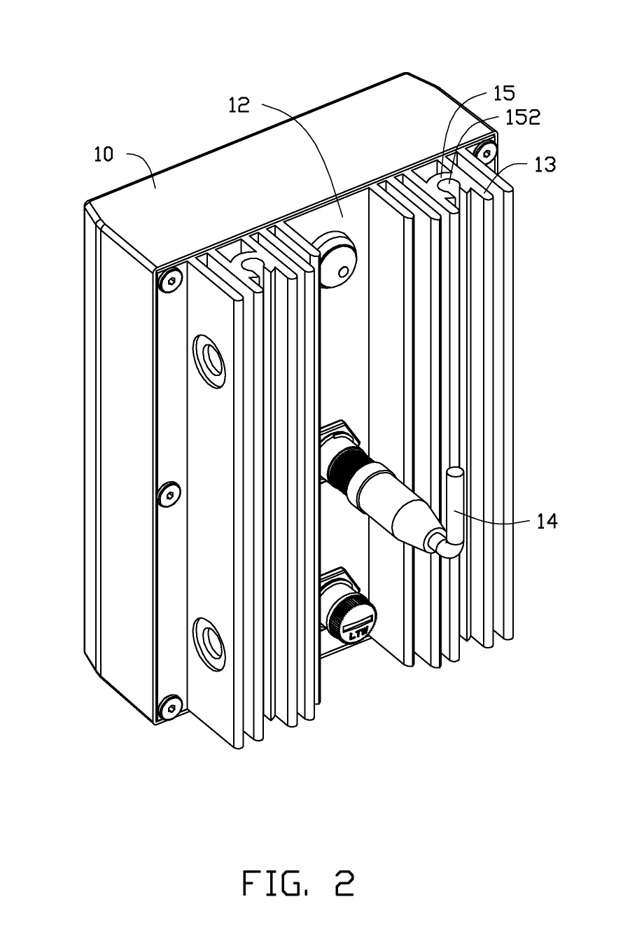

FIGS. 1 and 2 show an exemplary embodiment of an attachment mechanism for mounting two projection lamps 10. The attachment mechanism can comprise a fastening member 20, a pivot member 30, and two pairs of linkage poles 40.

Each projection lamp 10 can comprise a first side surface 11 for lights to extend through, and a second side surface 12 opposite to the first side surface 11. A cable 14 is connected to the second side surface 12 of the projection lamp 10. A plurality of long and parallel first fins 13 extends from the second side surface 12 of the projection lamp 10. A long second fin 15 is formed between two neighbor first fins 13, and is C-shaped in cross-section. Opposite ends of an inner surface 152 of the second fin 15 is threaded.

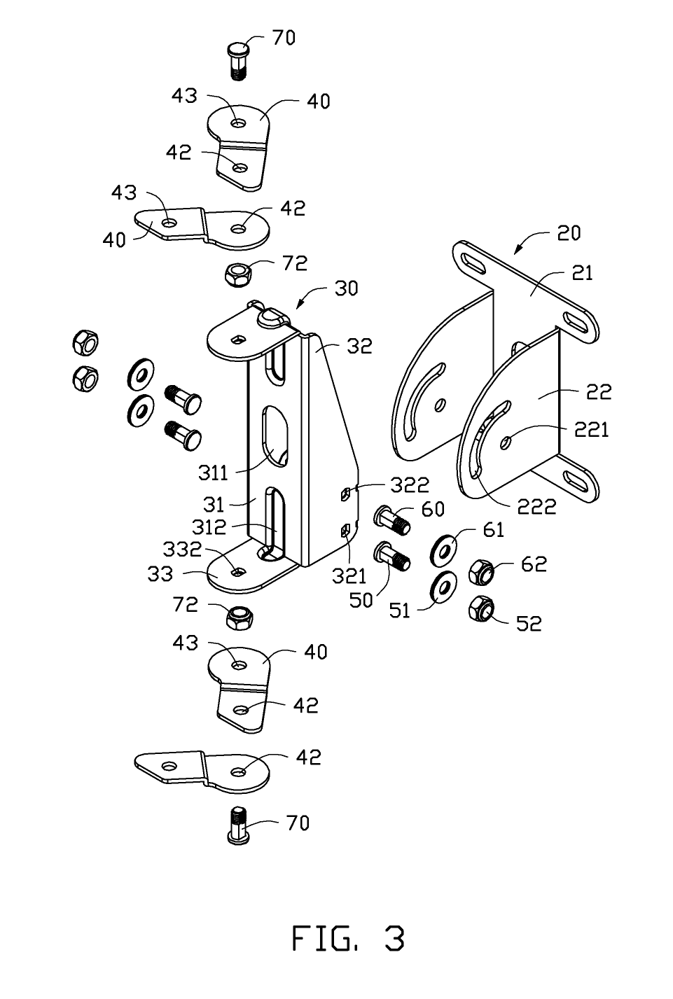

FIG. 3 shows the fastening member 20 comprising a fastening portion 21, and two pivot portions 22 perpendicularly extending from the fastening portion 21. Each pivot portion 22 defines a pivot hole 221, and an arched slide slot 222.

The pivot member 30 comprises a base plate 31, two side plates 32 perpendicularly extending from opposite sides of the base plate 31, and two end plates 33 perpendicularly extending from opposite ends of the base plate 31. The side plates 32 and the end plates 33 extend in opposite directions. The base plate 31 defines a through slot 311 for the cable 14 to extend through in a middle of the base plate 31. Two sunken portions 312 are defined in joints of the end plates 33 and the base plate 31. The two sunken portions 312 can strengthen the pivot member 30. Each side plate 32 defines a through hole 321 and a position hole 322. Each end plate 33 defines a through hole 332.

Each pair of linkage poles 40 comprises two linkage poles 40, one above another. Each linkage pole 40 is step-shaped and defines a through hole 42 in a lower portion of the linkage pole 40, and a mounting hole 43 in a higher portion of the linkage pole 40.

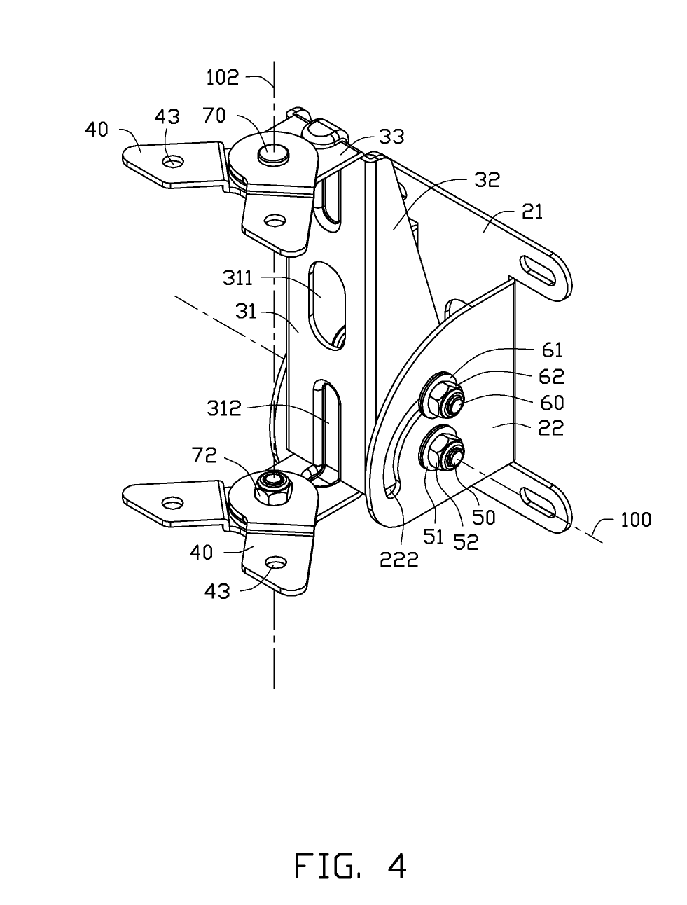

FIG. 4 shows that in assembly, the pivot member 30 is placed between the pivot portions 22 of the fastening member 20. Two fasteners 50 extend through the through holes 321, the pivot holes 221, two gaskets 51, and engage in two nuts 52, to pivotably connect the pivot member 30 to the fastening member 20 about a first axis 100. Wherein a center axis of the pivot holes 221 is defined as the first axis 100. When the pivot member 30 is rotated relative to the fastening member 20, the position holes 322 move along the slide slots 222. Two fasteners 60 extend through the position holes 322, the slide slots 222, two gaskets 61, and engage in two nuts 62, to fasten the pivot member 30 to the fastening member 20. Two of the linkage poles 40 are placed at opposite sides of one of the end plates 33. A fastener 70 extends through the through holes 42 of the two of the linkage poles 40, the through hole 332 of the one of the end plates 33, and engages in a nut 72, to pivotably connect the linkage poles 40 to the end plate 33. Wherein a center axis of the through holes 332 is defined as a second axis 102, and is perpendicular to the first axis 100. The linkage poles 40 are pivotable about the second axis 102. In the same manner, another two linkage poles 40 are pivotably connected to the other end plate 33 about the second axis 102.

FIG. 1 shows that to mount the two projection lamps 10, the fastening portion 21 of the fastening member 20 is fastened to a plane, such as a wall. The end plates 33 are arranged one above another. Two fasteners 80 extend through the mounting holes 43 of the upper two linkage poles 40, and engage in top ends of the second fins 15 of the projection lamps 10. Another two fasteners 80 extend through the mounting holes 43 of the lower two linkage poles 40, and engage in bottom ends of the second fins 15 of the projection lamps 10. Thus, two pairs of linkage poles 40 of the attachment mechanism attach two projection lamps 10 thereto, respectively.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. An attachment mechanism for two projection lamps, comprising:
a fastening member;
a pivot member pivotably connected to the fastening member about a first axis; and
two pairs of linkage poles pivotably connected to the pivot member about a second axis perpendicular to the first axis, each pair of linkage poles comprising two linkage poles, one above another, each pair of linkage poles to be fastened to opposite ends of one projection lamp.

2. The attachment mechanism of claim 1, wherein each pair of linkage poles is pivotably connected to opposite ends of the pivot member.

3. The attachment mechanism of claim 2, wherein the fastening member further comprises a fastening portion, and two pivot portions perpendicularly extending from the fastening portion, the pivot member comprises a base plate, and two side plates perpendicularly extending from opposite sides of the base plate, the side plates are pivotably connected to the pivot portions.

4. The attachment mechanism of claim 3, wherein each pivot portion defines a pivot hole, each side plate defines a through hole, two first fasteners extend through the through holes, the pivot holes, and engage in two first nuts, to pivotably connect the side plates to the pivot portions, the first axis is a center axis of the pivot holes.

5. The attachment mechanism of claim 4, wherein each pivot portion defines an arched slide slot, each side plate defines a position hole, two second fasteners extend through the position holes, the slide slots, and engage in two second nuts, to fasten the pivot member to the fastening member.

6. The attachment mechanism of claim 3, wherein the pivot member further comprises two end plates extending from opposite ends of the base plate and extending away from the side plates, each pair of linkage poles is pivotably connected to the end plates.

7. The attachment mechanism of claim 6, wherein each end plate defines a first through hole, each linkage pole defines a second through hole, two fasteners extend through the second through holes, the first through holes, and engage in two nuts, to pivotably connect the linkage poles to the end plates, the second axis is a center axis of the first through holes.

8. The attachment mechanism of claim 7, wherein each pair of linkage poles is fastened to opposite ends of fins extending from the corresponding projection lamp.

9. The attachment mechanism of claim 6, wherein the pivot member defines two sunken portions at joints of the end plates and the base plate.

10. The attachment mechanism of claim 3, wherein each base plate defines a through slot for a cable of the corresponding projection lamp extending through in a middle of the base plate.
